(19) United States
(12) Patent Application Publication
(10) Pub. No.: US 2007/0286177 A1
(43) Pub. Date: Dec. 13, 2007

(54) Connection controller, IP telephone communication system, connection control method and program

(75) Inventors: Katsuhiko Yamada, Tokyo (JP); Yasuhiro Mizukoshi, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 11/727,737

(22) Filed: Mar. 28, 2007

(30) Foreign Application Priority Data
Mar. 29, 2006 (JP) 2006-092221

(51) Int. Cl. H04L 12/66

(52) U.S. Cl. 370/356

(57) ABSTRACT

In an IP telephone communication system at least including a plurality of Access Points and stations under control of the Access Points, each of the Access Points determines presence or absence of a station in a silent state not conducting IP telephone communication among stations having established communication lines for IP telephone communication and conducts, when presence of the station in a silent state is determined, pseudo IP telephone communication corresponding to a state in which the station in a silent state conducts IP telephone communication. According to the system, even if there exists a station in the silent state not conducting IP telephone communication, it is possible to determine connectibility of IP telephone communication with high reliability.

### BACKGROUND OF THE INVENTION

1. Field of the Invention

The present invention relates to a connection controller, an Internet Protocol (IP) telephone communication system, a connection control method, and a program for determining connection of IP telephone communication, and in particular, to a connection controller, an IP telephone communication system, a connection control method, and a program for determining connection of IP telephone communication in a situation where mobile stations having established communication lines for IP telephone communication include mobile stations in a silent state in which the mobile stations are not conducting IP telephone communication.

2. Description of the Related Art

In the IP telephone communication system adopting the wireless Local Area Network (LAN), there exist problems such as the restriction on an Access Point, electric wave interference, and the restriction of communication protocols. Therefore, the number of mobile stations (stations) for which the predetermined service quality is guaranteed in the IP telephone communication is limited for an Access Point. In this situation, if there are so many stations that the service quality is not guaranteed, the sound and voice quality deteriorates and the telephone communication is interrupted. The deterioration in the sound and voice exerts an adverse influence on all stations communicating with the Access Point. To cope with the difficulty, the connection control functions such as call admission control are regarded as quite important measures.

The call admission control is implemented as below. For example, as can be seen from FIG. 1, when an Access Point AP1 receives an association request for IP telephone communication from an additional station STA (step A11), the Access Point AP1 or a management controller 100 determines whether it is possible for the station AP1 to secure a band for the communication. If it is determined that the station AP1 cannot reserve the band, the association request is rejected (step A12). According to the call admission control, the additional station STA intentionally connects to an optimal Access Point APN that can secure the band (step A13). This resultantly guarantees the predetermined service quality. In the configuration of FIG. 1, the management controller 100 is a control device to manage the respective Access Points AP1 and APN.

There has been proposed a system control method for use with the IP telephone communication system as follows. For example, as shown in FIG. 2, a first Access Point AP1 receives an association request for IP telephone communication from an additional station STA (step A21) and then transmits trial IP packet data of the IP telephone communication thus requested, to a second Access Point AP2 linked with a destination partner station STA as a association request destination (step A22). If the first Access Point AP1 determines that it is possible to reserve a band for the communication on a network NW between the first Access Point AP1 and the second Access Point AP2, the first Access Point AP1 allows the association request for IP telephone communication from the additional station STA (step A23). In this operation, depending on the band state of the network NW at transmission of the trial IP packet data, the first Access Point AP1 determines whether the association request for IP telephone communication from the additional station STA is allowed. Therefore, even if the additional station STA establishes the connection for IP telephone communication, the band can be reserved for the communication. This consequently guarantees the predetermined service quality for all stations for which the connection for IP telephone communication is granted.

However, as shown in FIG. 3, among a plurality of stations STA1 to STAN (N is an integer) having established connection to the first Access Point AP1 for IP telephone communication, there exists a station STAN in a silent state not conducting data communication for the IP telephone communication due to use of a function such as a silence compression function. Therefore, among the stations STA1 to STAN, the number of stations actually communicating data through IP telephone communication dynamically varies. This resultantly alters the band state of the network NW on the uplink side of the first Access Point AP1. As a result, the band state of the network NW becomes indeterminate.

Assume a situation in which an additional station STA not having established a communication line for IP telephone communication under supervision of the first Access Point AP1 issues a new association request for IP telephone communication, and then the first Access Point AP1 determines that the band for the communication can be secured on the network NW to grant the connection for the new IP telephone communication requested by the additional station STA. In this situation, if a station STAN in the silent state not conducting data communication for the IP telephone communication attempts to communicate data through the IP telephone communication, there occurs a state in which the band for the communication cannot be reserved on the network. This leads to a disadvantage depending on cases that the predetermined service cannot be guaranteed for the stations for which the connection for IP telephone communication is granted.

As above, the conventional Access Points AP1 to APN are attended with the difficulty, specifically, in a situation in which if the stations STA1 to STAN having established communication lines for IP telephone communication with the Access Points AP1 to APN include a silent stations STAN in the silent state, the association request of IP telephone communication from an additional station STA, which should be rejected, is granted and hence the additional station STA attempts to conduct the IP telephone communication, which should be rejected. Therefore, it is required to achieve a highly reliable control operation to allow the connection for IP telephone communication by giving consideration also to existence of the station STAN in the silent state exists.

There has been proposed a band confirmation apparatus described in, for example, document 1 (Japanese Patent Publication No. 3479637). In accordance with the technique of the article, the size of a band actually available for a confirmation objective device connected in a particular interval of a network is confirmed at a position different from that of the device. Specifically, the band of information communicated with the objective device is measured by accessing a predetermined band information acquiring unit to relay or to monitor the information. The technique includes a first step of receiving n1 measured values as an input without transmitting additional traffic to resultantly determine that the confirmation is successfully conducted if the n1 measured values include m1 measured values (m1 is a judge reference value) equal to or more than a reference value B, a second step of transmitting additional traffic of a band B2 determined by a statistic value obtained according to the values of the first step and receiving n2 measured values as an input to determine that the confirmation is successfully conducted if the number of measured values equal to or more than a reference value B is equal to or more than a determination reference value m2, and a third step of transmitting additional traffic of a band B3 and receiving n3 measured values as an input to determine that the confirmation is successfully conducted if the number of measured values equal to or more than a reference value B is equal to or more than a determination reference value m3 and the confirmation is ended with failure if the number of measured values equal to or more than a reference value B is less than the reference value m3. There can be accordingly obtained a more reliable result from the confirmation of the available band.

According to, for example, document 2 (Japanese Patent Application Laid-Open No. 2002-290478), there is described an audio packet communication path optimization method for use with a network in which a route between a general station and a mobile station via a gateway is optimized by a home agent and a call agent. The method includes a step in which before starting a telephone call, the gateway associated with the general station transmits, in response to a call or a call response from the mobile station, a dummy audio packet and a step in which the home agent managing the mobile station having received the dummy audio packet transmits a bind message including an address of the mobile station. When the bind message is received, the gate way starts the route optimization to obtain an optimized audio IP packet route before the telephone call is started.

Additionally, for example, document 3 (Japanese Patent Application Laid-Open No. 2005-244624) describes a packet transmission method in a station-control packet communication system for use with a system including a plurality of packet transfer units connected via a network to each other and at least one station connected to the packet transfer units. In the packet transmission method, a call source station transmits a packet addressed to a call destination station to a packet transfer unit, connected to the call source station, for a predetermined period of time at a priority level of a trial class. The call source station estimates whether the communication quality of the packet is sufficient. If the quality is sufficient, the call source station sends the packet as a packet of a priority class. The call source station sends a packet of a trial class also after the transmission of the packet of the priority class is started. Regardless of increase or decrease in the band of the actual use for the communication of a dominant class set according to a observation-type control method dominantly supervised on station side, any new communication inherently not to be allowed is rejected to thereby keep the communication quality.

Although document 1 describes a technique in which the size of the band actually available by the confirmation objective device connected to a particular interval on a network is confirmed at a place other than that of the objective device, consideration has not been given to a measure to cope with a situation in which there exists a station in a silent state.

Document 2 describes a technique for transmitting a dummy audio packet. However, the dummy audio packet is transmitted to obtain an optimized audio IP packet route before a telephone call is initiated. That is, the article does not pay attention to a method to cope with a situation in which there exists a station in a silent state.

According to the technique described in document 3, a trial-class packet is transmitted such that regardless of increase or decrease of the actual band used for dominant-class communication set according to an observation-type control method of station control type, a new communication request of communication that is not to be allowed is rejected. However, consideration has not been given to a measure to cope with presence of a station in a silent state.

### SUMMARY OF THE INVENTION

In view of the foregoing, it is an objective of the present invention, to provide a connection controller, an IP telephone communication system, a connection control method, and a connection control program for determining connectibility of IP telephone communication (whether an IP telephone can be connected) with high reliability even in a situation wherein there exists stations in a silent state where IP telephone communication is not conducted.

To achieve the objective, there is provided a connection controller including a silent state judge module for determining presence or absence of a station in a silent state not conducting IP telephone communication among stations having established communication lines for IP telephone communication and a pseudo IP telephone communication conducting module for conducting, when presence of the station in a silent state is determined, pseudo IP telephone communication corresponding to a state in which the station in a silent state conducts IP telephone communication.

The pseudo IP telephone communication conducting module may create pseudo IP packet data corresponding to a state in which the station in a silent state conducts IP telephone communication and sends the packet data to a network.

The pseudo IP telephone communication conducting module may send the packet data to a network by assigning a higher priority level to IP packet data actually in IP telephone communication.

Also, the connection controller may further include an IP telephone connectibility judge module that determines, in a state in which the pseudo IP telephone communication is being conducted, connectibility of IP telephone communication of an additional station additionally desiring IP telephone communication.

The IP telephone connectibility judge module may conduct trial IP telephone communication between the additional station and a Access Point coupled with a destination station to conduct IP telephone communication with the additional station, via a network; determines as a result of the trial IP telephone communication whether a predetermined band is securable on the network; determines that the IP telephone communication is connectable if it is determined that the predetermined band is securable; and determines that the IP telephone communication is not connectable if it is determined that the predetermined band is not securable.

The IP telephone connectibility judge module may conduct trial IP telephone communication between the additional station and a Access Point coupled with a destination station to conduct IP telephone communication with the additional station, via a network; collects communication quality information associated with communication quality of the trial IP telephone communication; sends the communication quality information to a connection managing unit managing connection control of IP telephone communication for the additional station; receives a judge result obtained by the connection managing unit by determining, based on the communication quality information, connectibility of IP telephone communication for the additional station; determines connectibility of IP telephone communication on the basis of the judge result; determines that the IP telephone communication is connectable if the judge result indicates connectibility of the IP telephone communication; and determines that the IP telephone communication is not connectable if the judge result does not indicate connectibility of the IP telephone communication.

Moreover, the IP telephone connectibility judge module may communicate trial IP packet data with the Access Point via the network to thereby conduct the trial IP telephone communication.

The IP telephone connectibility judge module may communicate the trial IP packet data by assigning a higher priority level to IP packet data actually in IP telephone communication.

The silent state judge module may analyze the IP packet data sent from the station, checks a transmission state of the IP packet data to determine whether the IP packet data of IP telephone communication is transmitted, and determines presence of a station in a silent state if it is determined that the IP packet data of IP telephone communication is not transmitted.

The IP packet data may include judge information to determine whether the IP packet data is data of IP packet data of telephone communication and the silent state judge module analyzes the IP packet data sent from the station, checks a transmission state of the IP packet data to determine, based on the judge information, whether the IP packet data of IP telephone communication is transmitted, and determines presence of a station in a silent state if it is determined that the IP packet data of IP telephone communication is not transmitted.

Furthermore, the IP telephone connectibility judge module may determine, when the association request for IP telephone communication is received from the additional station, connectibility of IP telephone communication for the additional station.

The IP telephone connectibility judge module may determine, when a control indication is received from a connection managing unit managing connection control of IP telephone communication for the additional station, connectibility of IP telephone communication for the additional station.

There is also provided an IP telephone communication system including a plurality of Access Points and stations under control of the Access Points. Each of the Access Points includes a silent state judge module that determines presence or absence of a station in a silent state not conducting IP telephone communication among stations having established communication lines for IP telephone communication and a pseudo IP telephone communication conducting module that conducts, when presence of the station in a silent state is determined, pseudo IP telephone communication corresponding to a state in which the station in a silent state conducts IP telephone communication.

The Access Point may create pseudo IP packet data corresponding to a state in which the station in a silent state conducts IP telephone communication and sends the packet data to a network.

Moreover, the Access Point may send the packet data to a network by assigning a higher priority level to IP packet data actually in IP telephone communication.

The IP telephone communication system may further include an IP telephone connectibility judge module that determines, in a state in which the pseudo IP telephone communication is being conducted, connectibility of IP telephone communication of an additional station additionally desiring IP telephone communication.

The Access Point may conduct trial IP telephone communication between the additional station and a second Access Point coupled with a destination station to conduct IP telephone communication with the additional station, via a network; determines as a result of the trial IP telephone communication whether a predetermined band is securable on the network; determines that the IP telephone communication is connectable if it is determined that the predetermined band is securable; and determines that the IP telephone communication is not connectable if it is determined that the predetermined band is not securable.

Additionally, the IP telephone communication system may further include a connection managing unit that manages connection control of IP telephone communication for the additional station. The Access Point conducts trial IP telephone communication between the additional station and a second Access Point coupled with a destination station to conduct IP telephone communication with the additional station, via a network; collects communication quality information associated with communication quality of the trial IP telephone communication; sends the communication quality information to the connection managing unit; receives from the connection managing unit a judge result obtained by the connection managing unit by determining, based on the communication quality information, connectibility of IP telephone communication for the additional station; determines connectibility of IP telephone communication on the basis of the judge result; determines that the IP telephone communication is connectable if the judge result indicates connectibility of the IP telephone communication; and determines that the IP telephone communication is not connectable if the judge result does not indicate connectibility of the IP telephone communication.

The Access Point may communicate trial IP packet data with the Access Point via the network to thereby conduct the trial IP telephone communication.

Also, the Access Point may communicate the trial IP packet data by assigning a higher priority level to IP packet data actually in IP telephone communication.

The Access Point may analyze the IP packet data sent from the station, checks a transmission state of the IP packet data to determine whether the IP packet data of IP telephone communication is transmitted, and determines presence of a station in a silent state if it is determined that the IP packet data of IP telephone communication is not transmitted.

Moreover, the IP packet data may include judge information to determine whether the IP packet data is data of IP packet data of telephone communication. The Access Point analyzes the IP packet data sent from the station, checks a transmission state of the IP packet data to determine, based on the judge information, whether the IP packet data of IP telephone communication is transmitted, and determines presence of a station in a silent state if it is determined that the IP packet data of IP telephone communication is not transmitted.

The Access Point may determine, when the association request for IP telephone communication is received from the additional station, connectibility of IP telephone communication for the additional station.

The Access Point may determine, when the association request for IP telephone communication is received from the additional station, connectibility of IP telephone communication for the additional station.

The Access Point may determine, when a control indication is received from a connection managing unit managing connection control of IP telephone communication for the additional station, connectibility of IP telephone communication for the additional station.

The IP telephone communication system may further include a connection managing unit that manages connection control of IP telephone communication for an additional station desiring to conduct IP telephone communication. The connection managing unit includes an IP telephone connectibility judge module that determines, in a state in which the wireless station is conducting the pseudo IP telephone communication, connectibility of the IP telephone communication for the additional station in a second Access Point coupled with the additional station.

The connection managing unit may conduct trial IP telephone communication between a first Access Point coupled with the additional station and a second Access Point coupled with a destination station to conduct IP telephone communication with the additional station, via a network; collects communication quality information associated with communication quality of the trial IP telephone communication via the network from the first and second Access Points; and determines connectibility of IP telephone communication on the basis of the communication quality information.

The connection managing unit may send a control indication to conduct the trial IP telephone communication to the first and second Access Points. The first and second Access Points communicate, at reception of the control indication, trial IP packet data therebetween via a network to thereby conduct the trial IP telephone communication.

The connection managing unit may determine whether the communication quality information is less than predetermined communication quality, determines that the IP telephone communication is connectable if it is determined that the communication quality information is equal to or more than predetermined communication quality, and determines that the IP telephone communication is not connectable if it is determined that the communication quality information is less than predetermined communication quality.

Moreover, the first and second Access Points may communicate the trial IP packet data with each other by assigning a higher priority level to IP packet data actually in IP telephone communication.

There is also provided a connection control method to be used by a connection control device for determining connectibility of IP telephone communication. The method includes a silent state judge step of determining presence or absence of a station in a silent state not conducting IP telephone communication among stations having established communication lines for IP telephone communication with the connection control device and a pseudo IP telephone communication conducting step of conducting, when presence of the station in a silent state is determined, pseudo IP telephone communication corresponding to a state in which the station in a silent state conducts IP telephone communication. The connection control device conducts the silent state judge step and the pseudo IP telephone communication conducting step.

The pseudo IP telephone communication conducting step may include creating IP packet data corresponding to a state in which the station in a silent state conducts IP telephone communication and sending the packet data to a network.

The pseudo IP telephone communication conducting step may include controlling to send the packet data to a network by assigning a higher priority level to IP packet data actually in IP telephone communication.

The connection control method may further include an IP telephone connectibility judge step of determining, in a state in which the pseudo IP telephone communication is being conducted, connectibility of IP telephone communication of an additional station additionally desiring IP telephone communication. The connection control device conducts the IP telephone connectibility judge step.

Also, the IP telephone connectibility judge step may include conducting trial IP telephone communication between the additional station and a Access Point coupled with a destination station to conduct IP telephone communication with the additional station, via a network; determining as a result of the trial IP telephone communication whether a predetermined band is securable on the network; determining that the IP telephone communication is connectable if it is determined that the predetermined band is securable; and determining that the IP telephone communication is not connectable if it is determined that the predetermined band is not securable.

The IP telephone connectibility judge step may include conducting trial IP telephone communication between the additional station and a Access Point coupled with a destination station to conduct IP telephone communication with the additional station, via a network; collecting communication quality information associated with communication quality of the trial IP telephone communication; sending the communication quality information to a connection managing unit managing connection control of IP telephone communication for the additional station; receiving a judge result obtained by the connection managing unit by determining, based on the communication quality information, connectibility of IP telephone communication for the additional station; determining connectibility of IP telephone communication on the basis of the judge result; determining that the IP telephone communication is connectable if the judge result indicates connectibility of the IP telephone communication; and determining that the IP telephone communication is not connectable if the judge result does not indicate connectibility of the IP telephone communication.

The IP telephone connectibility judge step may include communicating trial IP packet data with the Access Point via the network to thereby conduct the trial IP telephone communication.

The IP telephone connectibility judge step may include controlling to communicate the trial IP packet data by assigning a higher priority level to IP packet data actually in IP telephone communication.

Furthermore, the silent state judge step may include analyzing the IP packet data sent from the station, checking a transmission state of the IP packet data to determine whether the IP packet data of IP telephone communication is transmitted, and determining presence of a station in a silent state if it is determined that the IP packet data of IP telephone communication is not transmitted.

The IP packet data may include judge information to determine whether the IP packet data is data of IP packet data of telephone communication. The silent state judge step includes analyzing the IP packet data sent from the station, checking a transmission state of the IP packet data to determine, based on the judge information, whether the IP packet data of IP telephone communication is transmitted, and determining presence of a station in a silent state if it is determined that the IP packet data of IP telephone communication is not transmitted.

The IP telephone connectibility judge step may include determining, when the association request for IP telephone communication is received from the additional station, connectibility of IP telephone communication for the additional station.

The IP telephone connectibility judge step may include determining, when a control indication is received from a connection managing unit managing connection control of IP telephone communication for the additional station, connectibility of IP telephone communication for the additional station.

There is provided a computer program for use with a connection control device for determining connectibility of IP telephone communication. The program makes the connection control device execute silent state judge processing for determining presence or absence of a station in a silent state not conducting IP telephone communication among stations having established communication lines for IP telephone communication with the connection control device and pseudo IP telephone communication conducting processing for conducting, when presence of the station in a silent state is determined, pseudo IP telephone communication corresponding to a state in which the station in a silent state conducts IP telephone communication.

The pseudo IP telephone communication conducting processing may include creating pseudo IP packet data corresponding to a state in which the station in a silent state conducts IP telephone communication and sending the packet data to a network.

The pseudo IP telephone communication conducting processing may include controlling to send the packet data to a network by assigning a higher priority level to IP packet data actually in IP telephone communication.

The computer program may further make the connection control device execute IP telephone connectibility judge processing for determining, in a state in which the pseudo IP telephone communication is being conducted, connectibility of IP telephone communication of an additional station additionally desiring IP telephone communication.

The IP telephone connectibility judge processing may include conducting trial IP telephone communication between the additional station and a Access Point coupled with a destination station to conduct IP telephone communication with the additional station, via a network; determining as a result of the trial IP telephone communication whether a predetermined band is securable on the network; determining that the IP telephone communication is connectable if it is determined that the predetermined band is securable; and determining that the IP telephone communication is not connectable if it is determined that the predetermined band is not securable.

The IP telephone connectibility judge processing may include conducting trial IP telephone communication between the additional station and an Access Point coupled with a destination station to conduct IP telephone communication with the additional station, via a network; collecting communication quality information associated with communication quality of the trial IP telephone communication; sending the communication quality information to a connection managing unit managing connection control of IP telephone communication for the additional station; receiving a judge result obtained by the connection managing unit by determining, based on the communication quality information, connectibility of IP telephone communication for the additional station; determining connectibility of IP telephone communication on the basis of the judge result; determining that the IP telephone communication is connectable if the judge result indicates connectibility of the IP telephone communication; and determining that the IP telephone communication is not connectable if the judge result does not indicate connectibility of the IP telephone communication.

The IP telephone connectibility judge processing may include communicating trial IP packet data with the Access Point via the network to thereby conduct the trial IP telephone communication.

The IP telephone connectibility judge processing may include controlling to communicate the trial IP packet data by assigning a higher priority level to IP packet data actually in IP telephone communication.

The silent state judge processing may include analyzing the IP packet data sent from the station, checking a transmission state of the IP packet data to determine whether or not the IP packet data of IP telephone communication is transmitted, and determining presence of a station in a silent state if it is determined that the IP packet data of IP telephone communication is not transmitted.

The IP packet data may include judge information to determine whether the IP packet data is data of IP packet data of telephone communication. The silent state judge processing includes analyzing the IP packet data sent from the station, checking a transmission state of the IP packet data to determine, based on the judge information, whether the IP packet data of IP telephone communication is transmitted, and determining presence of a station in a silent state if it is determined that the IP packet data of IP telephone communication is not transmitted.

The IP telephone connectibility judge processing may include determining, when the association request for IP telephone communication is received from the additional station, connectibility of IP telephone communication for the additional station.

The IP telephone connectibility judge processing may include determining, when a control indication is received from a connection managing unit managing connection control of IP telephone communication for the additional station, connectibility of IP telephone communication for the additional station.

In accordance with the present invention, a check is made to determine whether stations having established communication lines for IP telephone communication include a station in a silent state not conducting IP telephone communication. If it is determined that the stations include a silent station, the system conducts pseudo IP telephone communication corresponding to a state in which the silent station conducts IP telephone communication. This makes it possible to set all stations having established communication lines for IP telephone communication to the state in which the stations are conducting the IP telephone communication. Therefore, even if the stations having established communication lines for IP telephone communication include a station in the silent state, there can be carried out a control operation for determining connectibility of IP telephone communication with high reliability.

### BRIEF DESCRIPTION OF THE DRAWINGS

The objectives and features of the present invention will become more apparent from the consideration of the following detailed description taken in conjunction with the accompanying drawings in which:

FIG. 1 is a diagram for explaining an example of the call admission control;

FIG. 2 is a diagram for explaining a processing example to determine connectibility of IP telephone communication for an additional station (STA) according to trial IP packet data;

FIG. 3 is a diagram for explaining a problem when there exists a station in a silent state;

FIG. 4 is a schematic block diagram for explaining a system configuration of an IP telephone communication system of a first embodiment;

FIG. 5 is a diagram showing an internal configuration of Access Point (AP1 to APN);

FIG. 6 is a flowchart showing a control operation to set all stations (STA1 to STAN) having established communication lines for IP telephone communication to a state in which the stations are conducting the IP telephone communication;

FIG. 7 is a sequence chart showing a processing sequence;

FIG. 8 is a block diagram showing a system configuration of an IP telephone communication system of a second embodiment;

FIG. 9 is a diagram showing an internal configuration of a mesh connection managing device (1);

FIG. 10 is a diagram showing internal structure of a mesh Access Point (A to F);

FIG. 11 is a diagram showing an internal configuration of a mesh portal (10);

FIG. 12 is a schematic diagram for explaining processing;

FIG. 13 is a sequence chart showing a processing sequence;

FIG. 14 is a block diagram showing a system configuration of an IP telephone communication system of a third embodiment;

FIG. 15 is a diagram for explaining first processing;

FIG. 16 is a sequence chart for explaining the first processing;

FIG. 17 is a diagram for explaining second processing; and

FIG. 18 is a sequence chart for explaining the second processing.

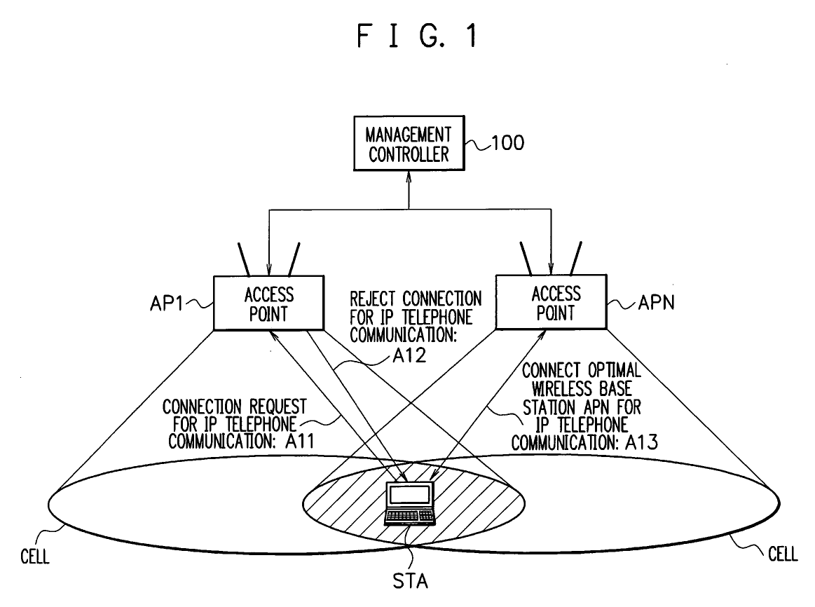

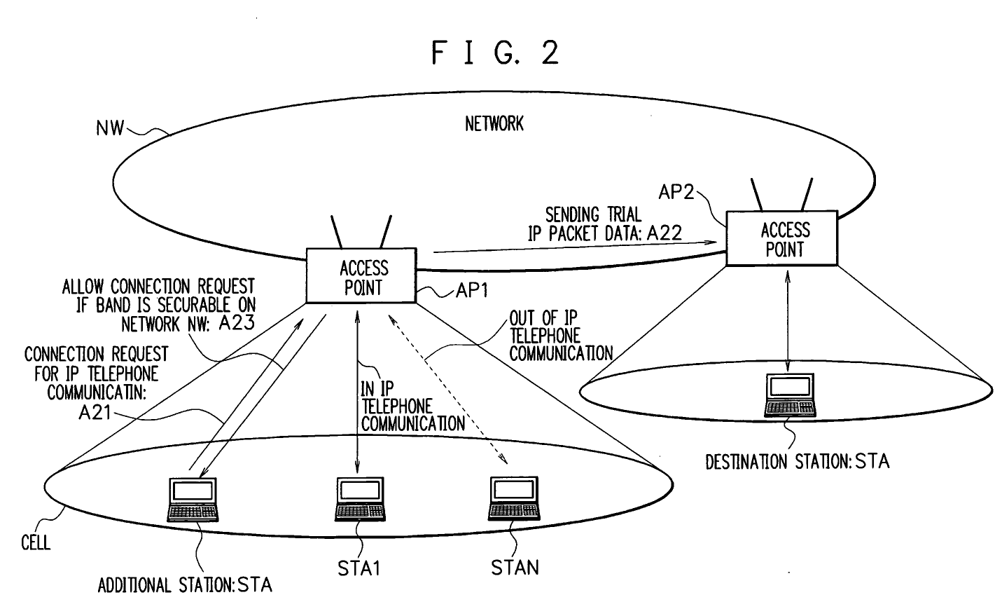

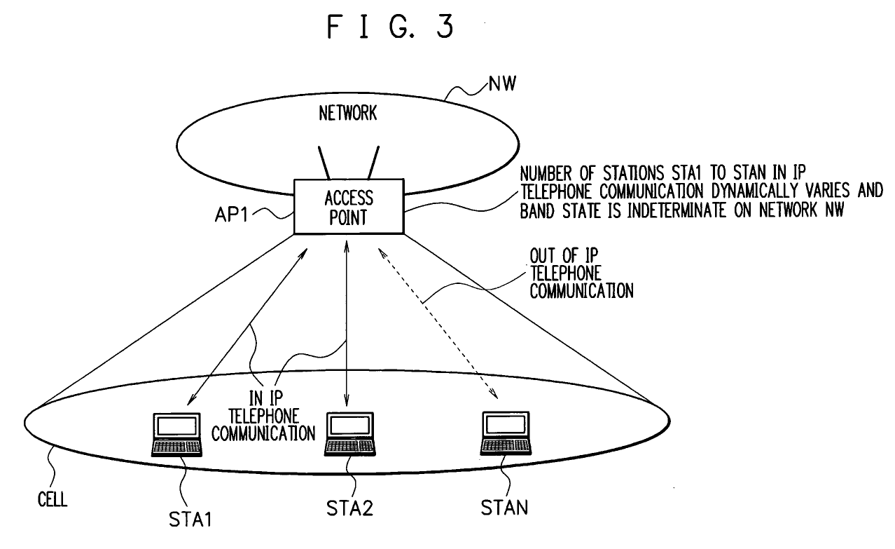

### DESCRIPTION OF THE EMBODIMENTS

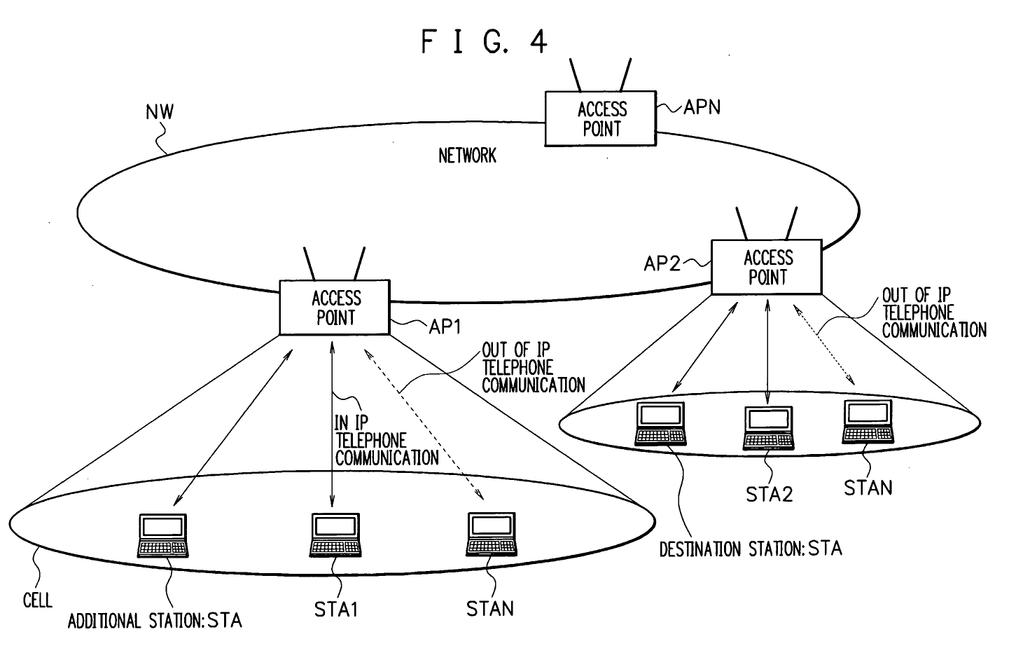

Referring now to FIG. 4, description will be given of an IP telephone communication system.

The IP telephone communication system at least includes a plurality of Access Points AP1 to APN (N is an integer) and a plurality of (mobile) stations STA to STN under control of each of the Access Points AP1 to APN.

Each of the Access Points AP1 to APN determines whether stations (STA1 to STAN) having established communication lines for IP telephone communication include a station STAN in a silent state (where IP communication is not conducted). If such a silent station STAN exists, the system conducts pseudo IP telephone communication corresponding to a state in which the silent station STAN conducts IP telephone communication. It is hence possible to set all stations (STA1 to STAN) having established communication lines for IP telephone communication with associated Access Points (AP1 to APN) to a state in which the stations are virtually conducting IP telephone communication. Therefore, even in a situation in which the stations (STA1 to STAN) having established communication lines for IP telephone communication with associated Access Points (AP1 to APN) include a station in the silent state, it is possible to determine connectibility of a station for IP telephone communication with high reliability. Referring next to the accompanying drawings, description will be given in detail of the IP telephone communication system according to the embodiments.

### First Embodiment

First, referring to FIG. 4, description will be given of structure of an IP telephone communication system.

The system includes a plurality of Access Points AP1 to APN (N is an integer) and a plurality of stations STA1 to STAN under supervision of each of the Access Points AP1 to APN as shown in FIG. 4. The Access Points AP1 to APN are connected to a network NW. As the stations STA1 to STAN, there may be employed communication devices capable of wireless communication such as Personal Digital Assistants (PDA) and Personal Computers (PC).

### <Access Points AP1 to APN>

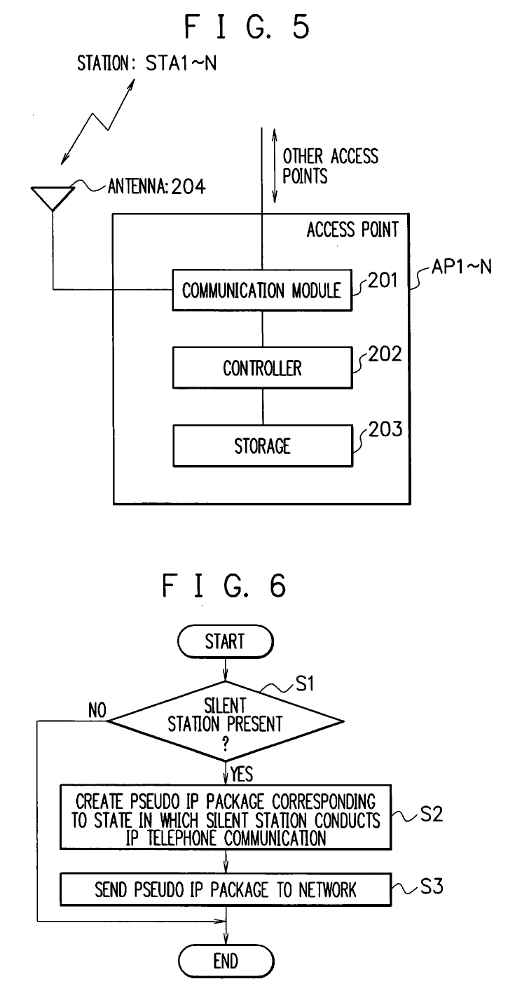

Each of the Access Points AP1 to APN establishes a communication line of IP telephone communication with the stations STA1 to STAN to communicate data and information with other Access Points. Referring next to FIG. 5, description will be given of an internal structure of the Access Points AP1 to APN.

Each Access Point includes a communication module 201, a control module 202, a storage section 203, and an antenna 204 as shown in FIG. 5.

The module 201 establishes IP telephone communication with one of the stations STA1 to STAN to communicate data over a particular frequency. The module 201 also communicates information with another Access Point.

The module 202 supervises operations in an Access Point. The section 203 stores various setting values and temporarily saves information communicated via the module 201. The setting values include, for example, a maximum band state that the Access Point can have, a radio channel, and a Service Set IDentifier (SSID).

### <Processing Sequence in First Embodiment>

Referring now to FIG. 6, description will be given of a processing sequence in the first embodiment.

Each Access Point conducts a pseudo IP telephone communication. The pseudo IP telephone communication is a control operation to make a situation where all the stations that possess communication lines conduct IP telephone communication. The control operation will next be described by referring to FIG. 6.

First, an Access Point (AP1 to APN) determines whether the stations (STA1 to STAN) having established communication lines include a station STAN in a silent state (step S1).

If it is determined that there does not exist such a silent station STAN (no in step S1), the Access Point terminates the processing (End). Otherwise (yes in step S1), the Access Point creates pseudo IP packet data corresponding to a state in which the silent station STAN carries out IP telephone communication (step S2). The Access Point then sends the data to the network NW on the uplink side. This sets the stations having established communication lines with the Access Point to a state in which the stations are conducting virtual IP telephone communication.

Whether the stations having established communication lines for IP telephone communication include a station in the silent state is determined using, for example, a first determination method as below.

### <First Determination Method>

An Access Point (AP1 to APN) analyzes IP packet data of the communication protocols such as Session Initiation Protocol (SIP) and Real-time Transport Protocol (RTP) sent from each station having established the communication line for IP telephone communication to examine a state of transmission of the IP packet data to determine whether the pertinent station is transmitting IP packet data of IP telephone communication. If it is determined that the station is transmitting other than the IP packet data of IP telephone communication, it is determined that there exists a station STAN in the silent state.

The first method is applicable to a situation in which the IP packet data is not encrypted. If the data is encrypted, there can be used a second determination method as below.

### <Second Determination Method>

A station (STA1 to STAN) creates, in a Type Of Service (TOS) field of the IP header, IP packet data including information to determine whether IP telephone communication is to be carried out and then sends the data to the associated Access Point (AP1 to APN). When the data is received, the Access Point analyzes the TOS field to examine the state of transmission of the data. If it is determined that the station is transmitting other than IP packet data for IP telephone communication, the Access Point determines that there exists a station in the silent state.

In this connection, the Access Point conducts the control operation shown in FIG. 6 to set all stations having established communication lines for IP telephone communication with the Access Point to the state in which the stations are virtually conducting the IP telephone communication. As a result, there can be established a state in which all such stations coupled with the network NW are communicating data through virtual IP telephone communication to thereby set the network to a maximum band state. The maximum band state indicates a band state in which all Access Points AP1 to APN linked with the network carry out the control operation of FIG. 6.

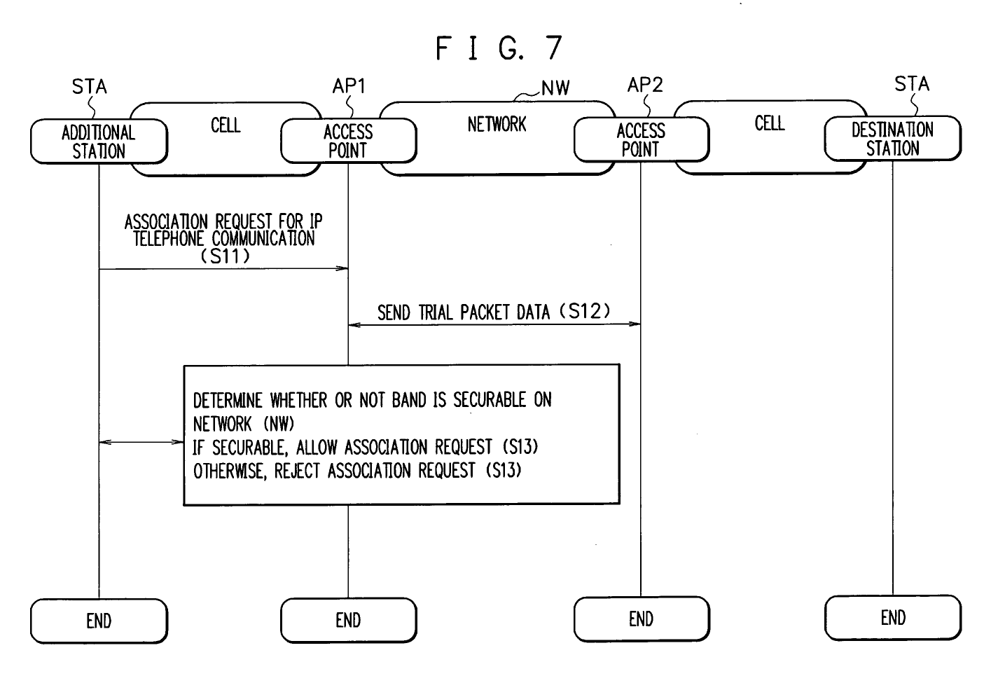

In the maximum band state, for example, if the first Access Point AP1 receives a association request for IP telephone communication from an additional station STA not having established a communication line for IP telephone communication as shown in FIG. 7 (step S11), the station AP1 delivers, to the second Access Point AP2 coupled with the destination station STA as the destination of the IP telephone communication, trial IP packet data required to carry out IP telephone communication between the additional station STA and the destination station STA (step S12). Based on information used at transmission of the trial IP packet data, the first Access Point AP1 determines whether a predetermined band is securable on the network between the first Access Point AP1 and the second Access Point AP2. If it is determined that the band can be reserved, the first Access Point AP1 accepts the association request for IP telephone communication from the additional station STA (step S13) to establish connection to the additional station STA for the IP telephone communication.

If it is determined that the band is not reserved, the first Access Point AP1 rejects the association request for IP telephone communication from the additional station STA (step S13).

Each of the Access Points AP1 to APN carries out the control operation shown in FIG. 6 to set the network linked with the Access Point to the maximum band state. In this situation, for example, the first Access Point AP1 receives the association request for IP telephone communication from the additional station STA and determines that the predetermined band can be secured on the network to thereby accept the request. Thereafter, even if the station STAN in the silent state conducts data communication using the IP telephone communication, it is guaranteed that the band can be secured on the network. This consequently guarantees the predetermined service or communication quality for all stations that are allowed to conduct IP telephone communication.

The method of determining whether the predetermined band is securable on the network is not particularly limited. That is, there may be employed any determination method if it is possible to determine, for the network in the maximum band state, whether the band is securable on the network according to information obtained when the trial IP packet data is transmitted

In the IP telephone communication system, the system favorably controls operations such that the IP packet data used for the pseudo IP telephone communication and employed for the trial IP telephone communication are sent to the network with a priority level lower than that of the IP packet data actually being transmitted through the IP telephone communication. As a result, even if the pseudo IP telephone communication or the trial IP telephone communication is carried out, the load imposed on the network can be mitigated. Also, the IP packet data actually being transmitted through the IP telephone communication on the network can be transmitted with a higher priority level. Therefore, it is possible to reduce the influence on the actually communication of the IP packet data through the IP telephone communication. In addition, since the check for connectibility of the additional station (STA) for the IP telephone communication is made under a severe environment, the result of the determination of connectibility for the IP telephone communication is attainable with further higher reliability.

As a method of controlling operation such that the IP packet data used for the pseudo IP telephone communication and employed for the trial IP telephone communication are sent to the network with a priority level lower than that of the IP packet data actually being transmitted through the IP telephone communication, there may be adopted a method in which, for example, IP packet data including priority information indicating a priority level is transmitted to the network.

### Second Embodiment

Next, description will be given of a second embodiment.

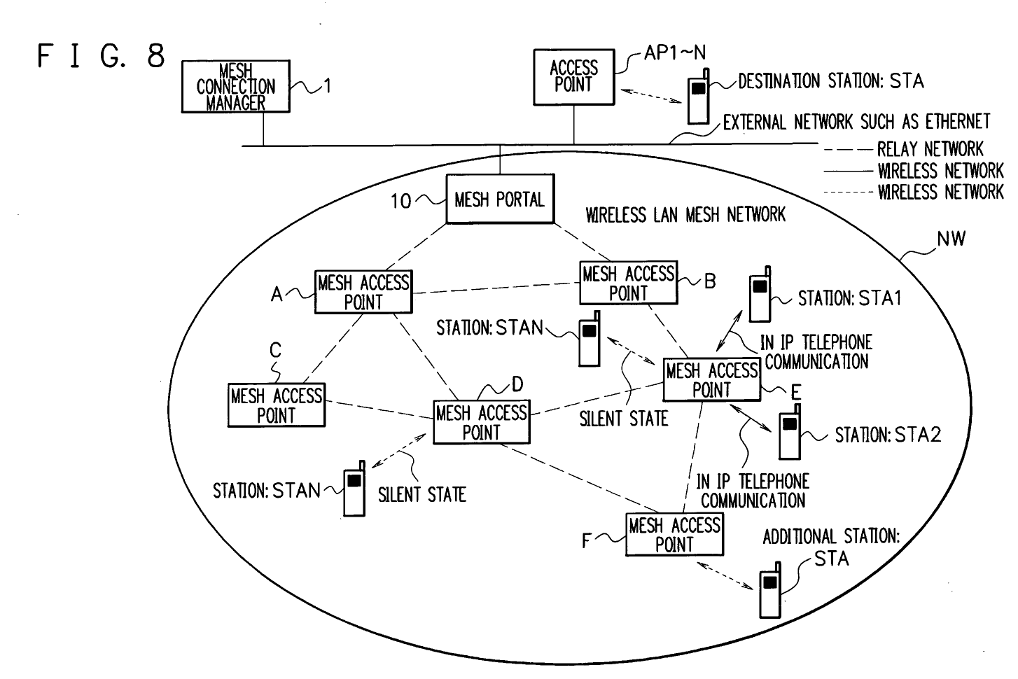

An IP telephone communication system is constructed in the form of a wireless LAN mesh network as shown in FIG. 8. Each mesh Access Point (A to F) and a mesh portal 10 conduct a control operation shown in FIG. 6 such that any station (STA1 to STAN) having established a communication line for IP telephone communication with one of the mesh Access Points A to F or the mesh portal 10 enters a state in which the station is virtually conducting the IP telephone communication. In this state, if an additional station STA not having established IP telephone communication issues an association request for IP telephone communication, trial IP telephone communication is carried out between the mesh Access Point connected to the additional station STA and the mesh portal 10 coupled with a destination station STA indicated as the destination of IP telephone communication with the additional station STA. According to a result of the trial IP telephone communication, it is determined whether the additional station STA is connectable for the IP telephone communication. Referring now to FIGS. 8 to 13, description will be given in detail of the second embodiment.

Referring now to FIG. 8, description will be given of an IP telephone communication system.

The communication system includes a mesh connection manager device 1, a mesh portal unit 10, a plurality of mesh Access Points A to F, and a plurality of stations STA1 to STAN.

In the communication system, the mesh portal 10, the Access Points A to F, and the stations STA1 to STAN form a radio LAN mesh network NW. The mesh network includes radio networks between the stations STA1 to STAN and the Access Points A to F and relay networks between the Access Points A to F and between the mesh portal and the Access Points A and B. The radio networks and the relay networks favorably use mutually different radio channels to thereby prevent interference between radio waves.

It is assumed in the embodiment that the wireless LAN mesh network NW conforms to the definitions of functional elements prescribed by IEEE802.11s. The functional elements to configure the relay network in the form of a mesh are called mesh points. Among the mesh points, a mesh point providing a function of a Access Point is called a mesh Access Point (A to F) and a mesh point providing a gateway function for an external network such as ethernet (registered trademark) is called a mesh portal (10). The mesh portal (10) may include a function similar to that of the mesh Access Point (A to F).

### <Mesh Connection Managing Unit 1>

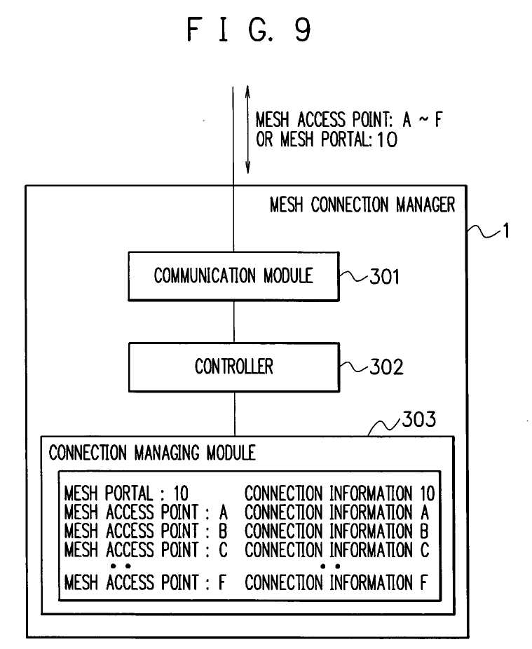

Referring to FIG. 9, description will be given of an internal configuration of the mesh connection manager 1.

The connection manager 1 is an information processing unit to control the mesh Access Points A to F and the mesh portal 10 configuring the wireless LAN mesh network. As shown in FIG. 9, the manager 1 includes a communication module 301, a control module 302, and a connection managing module 303.

The module 301 communicates information with the Access Points A to F and the mesh portal 10. In the information communication, the communication module 301 may employ a desired communication mode only if information can be communicated therebetween. For example, information may be transmitted through wired communication or wireless communication.

The module 302 supervises operations in the mesh connection manager 1. When a connection judge request of IP telephone communication for an additional station STA additionally desiring IP telephone communication is received from one of the mesh Access Points A to F or the mesh portal 10, the module 302 issues a control indication to carry out trial IP telephone communication between the Access Point or the mesh portal 10 and a destination station STA as the destination of IP telephone communication of the additional station STA or the mesh portal 10. Thereafter, the module 302 receives information of communication quality obtained as a result of the trial IP telephone communication conducted by the mesh Access Point or the mesh portal 10. Based on the communication quality information, the module 302 determines connectibility of the IP telephone communication. The module 303 controls connection information of the mesh Access Points A to F on the mesh network or the stations STA1 to STAN coupled with the mesh portal 10. On the basis of the connection information of the module 303, the module 302 can recognize the Access Points A to F on the mesh network or the stations STA1 to STAN coupled with the mesh portal 10.

### <Mesh Access Points A to F>

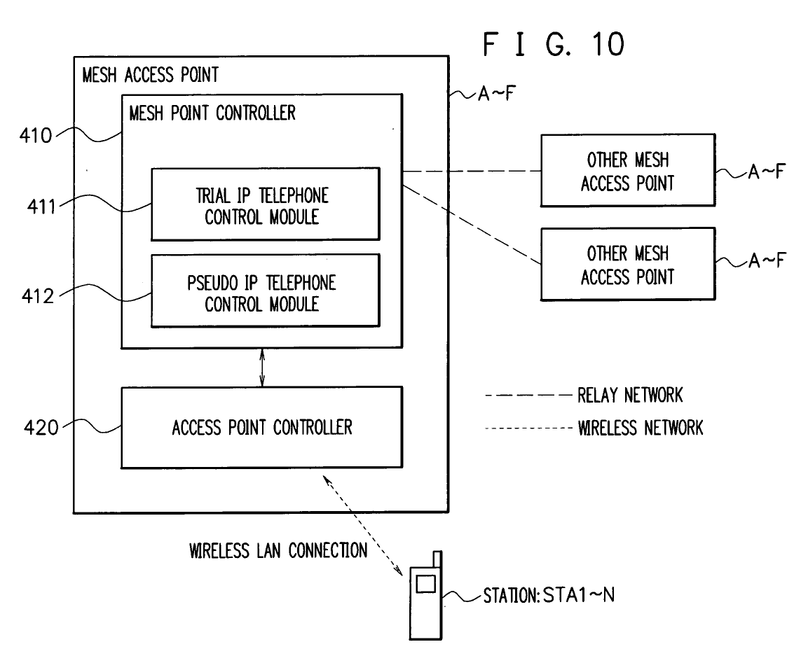

Referring next to FIG. 10, description will be given of internal structure of the mesh Access Points A to F.

In the second embodiment, each of the Access Points A to F includes a mesh point controller 410 and an access point controller 420 as shown in FIG. 10. The mesh point controller 410 supervises communication between the mesh connection manager 1, the mesh portal 10, and other mesh Access Points A to F. The mesh point controller 410 is disposed to control communication between the mesh Access Point (A to F) and the station (STA1 to STAN) having established a wireless communication line. The mesh point controller 410 includes a trial IP telephone control module 411 and a pseudo IP telephone control module 412.

The module 411 carries out trial IP telephone communication using dummy IP packet data. When an association request for IP telephone communication is received from an additional station STA not having established IP telephone communication, the module 411 issues a connection judge request for IP telephone communication to the mesh connection manager 1. According to a control indication from the connection manager 1, the module 411 communicates the dummy IP packet data with a mesh Access Point (A to F) or the mesh portal 10 connected to a destination station STA as the communication destination of the additional station STA to thereby conduct the trial IP telephone communication. As a result of the communication, the module 411 collects information such as delay, deviation, and a packet loss taking place during the communication, as communication quality information required to evaluate quality of the IP telephone communication. The module 411 then delivers the information to the mesh connection manager 1.

Like the module 411, the module 412 conducts IP telephone communication using the dummy PI packet data and controls operations similar to that shown in FIG. 6. The module 412 determines whether the stations (STA1 to STAN) having established communication lines for IP telephone communication with the mesh Access Point (A to F) include a station STAN in the silent state. If it is determined that such a station is included, the module 412 creates pseudo IP packet data corresponding to a state in which the silent station STAN conducts IP telephone communication. The module 412 then sends the pseudo data to the wireless LAN mesh network. Therefore any station (STA1 to STAN) having established a communication line for IP telephone communication with the mesh Access Point (A to F) is set to a state in which the station is virtually conducting IP telephone communication.

### <Mesh Portal 10>

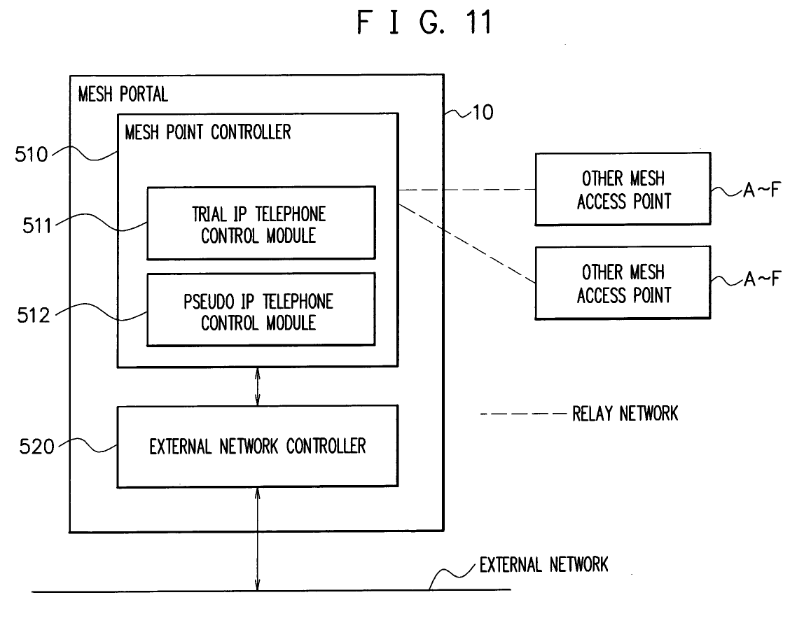

Next, description will be given of internal structure of the mesh portal 10 by referring to FIG. 11.

The mesh portal 10 includes a mesh point control module 510 and an external network control module 520 as shown in FIG. 11. The module 510 controls communication with the mesh Access Points A to F or with the mesh connection manager 1. The module 520 supervises connection between the station STA connected to an external network and the station (STA1 to STAN) coupled with the mesh Access Point (A to F) on the wireless LAN mesh network. The module 510 includes a trial IP telephone control module 511 and a pseudo IP telephone control module 512.

In this connection, the module 511 conducts control in a way similar to that of the module 411 of the mesh Access Point (A to F) shown in FIG. 10.

The module 512 carries out pseudo IP telephone communication in addition to the control operation of the module 412 of the mesh Access Point (A to F) shown in FIG. 10. Specifically, while the station coupled with an external network is not communicating data through IP telephone communication, the module 412 conducts pseudo IP telephone communication corresponding to a state in which the station is performing IP telephone communication.

### <Processing in Connection Control System>

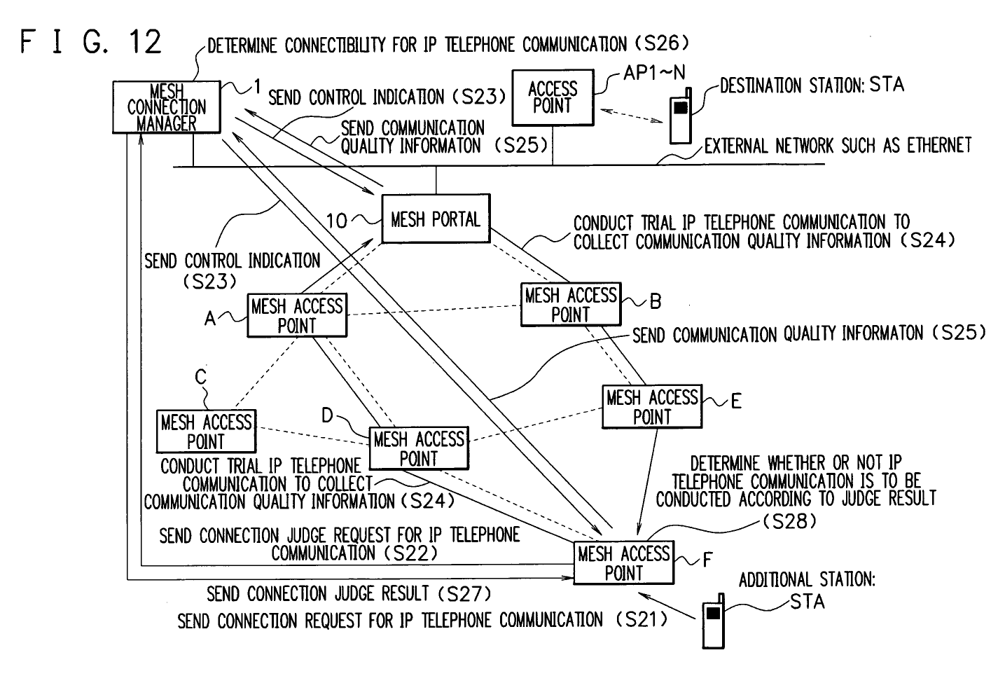

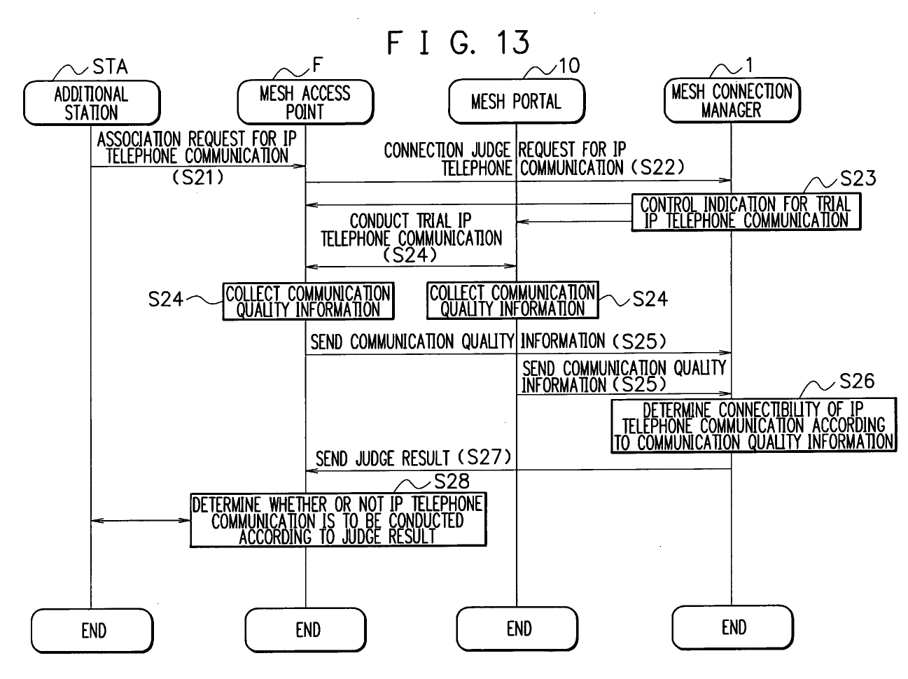

Referring next to FIGS. 12 and 13, description will be given of a sequence of processing steps executed in the IP telephone communication system.

In the following description of processing, as can be seen from FIGS. 8 and 12, an additional station STA not having established a communication line for IP telephone communication with the mesh Access Point (A to F) on the wireless LAN mesh network issues to a mesh Access Point F an association request for IP telephone communication to communicate with a determination station STA coupled with an external network.

First, the mesh Access Points A to F and the mesh portal 10 configuring the mesh network carry out control operation similar to that shown in FIG. 6 to set any station (STA1 to STAN) having established IP telephone communication with one of the Access Points A to F or the mesh portal 10 to a state in which the station is virtually communicating data through IP telephone communication.

As a result, each station (STA1 to STAN) having established a communication line for IP telephone communication with one of the Access Points A to F or the mesh portal 10 is set to the state in which the station is virtually communicating data through IP telephone communication, and hence the mesh network can be set to the maximum band state.

The maximum band state is a band state established when all Access Points A to F and the mesh portal 10 on the mesh network conduct a control operation similar to that shown in FIG. 6.

In the maximum band state of the mesh network, the additional station STA sends to the Access Point F an association request for IP telephone communication with the destination station STA coupled with the external network (step S21).

When the association request is received, the Access Point F delivers a connection judge request of IP telephone communication associated with the association request to the mesh connection manager 1 (step S22).

After having received the connection judge request, the manager 1 transmits a control indication to carry out trial IP telephone communication to the Access Point F connected to the additional station STA as the request source and the mesh portal coupled with the destination station STA as the destination of the request (step S23).

When the control indication to carry out the trial IP telephone communication is received from the manager 1, the Access Point F and the mesh portal 10 create trial IP packet data including dummy data capable of identifying that the communication is IP telephone communication on the mesh network by setting, for example, a message format conforming to Real-time Transport Protocol (RTP) or RTP Control Protocol (RTCP) and a Type Of Service (TOS) field of the IP packet. The portal 10 and the Access Point F mutually communicate the trial IP packet data via a relay network with each other and resultantly gather communication quality information such as delay, deviation, a packet loss required to evaluate quality of the IP telephone communication (step S24).

The Access Point F and the mesh portal 10 send the communication quality information to the mesh connection manager 1 (step 25).

The manager 1 receives the information from the Access Point F and the mesh portal 10 to determine, based on the information, whether the IP telephone communication satisfies predetermined communication quality. If it is determined that the communication satisfies the predetermined quality, the manager 1 allows the connection for IP telephone communication. Otherwise, the manager 1 rejects the connection for IP telephone communication (step 26). Thereafter, the manager 1 delivers, in response to the connection judge request, the connection judge result to the Access Point F (step S27).

According to the judge result from the manager 1, the Access Point F determines whether the association request from the station STA is accepted (step S28). If the judge result indicates that the connection is rejected, the Access Point F rejects the association request. If the judge result indicates that the connection is granted, the Access Point F allows the association request.

As above, in the embodiment of an IP telephone communication system, each of the mesh Access Points A to F and the mesh portal 10 on the wireless LAN mesh network NW determine whether the stations (STA1 to STAN) having established a communication line for IP telephone communication with one of the mesh Access Points A to F or the mesh portal 10 include a station STAN in the silent state not communicating data through IP telephone communication. If it is determined that such a station STAN in the silent state is included, the Access Points A to F and the portal 10 each carry out the pseudo IP telephone communication corresponding to a state in which the station STAN is communicating data through IP telephone communication. This resultantly leads to a state in which each of the stations STA1 to STAN having established a communication line for IP telephone communication on the mesh network is virtually communicating data through IP telephone communication to thereby set the mesh network to the maximum band state.

In the maximum band state of the mesh network, if the station STA not having established a communication line for IP telephone communication issues an association request for IP telephone communication, data is communicated through trial IP telephone communication between the Access Point F coupled with the station STA and the mesh portal 10 connected to a destination station STA as the destination of IP telephone communication with the station STA. The Access Point F and the portal 10 collect communication quality information resultant from the operation to communicate data through trial IP telephone communication to send the information to the unit 1. On the basis of the communication quality information from the Access Point F and the portal 10, the managing unit 1 determines connectibility of the station STA for IP telephone communication.

Resultantly, in the maximum band state of the wireless LAN mesh network, it is possible to determine connectibility of the station STA desiring to additionally conduct IP telephone communication for IP telephone communication. Therefore, even if the stations (STA1 to STAN) having established communication lines for IP telephone communication on the mesh network include a station STAN in the silent state, the connectibility for IP telephone communication can be determined with high reliability.

Also, even if the station STAN in the silent state communicates data through IP telephone communication after the connection of the station STA for IP telephone communication is granted, since predetermined communication quality can be guaranteed on the mesh network in any situation, it is possible under any condition to guarantee predetermined service quality for all stations allowed for the connection for IP telephone communication.

In the determination of connectibility for IP telephone communication in step S26, the mesh connection manager 1 determines, on the basis of the communication quality information from the Access Point F and the portal 10, whether the communication satisfies the predetermined communication quality. The determination may be conducted, for example, as below. The communication states such as delay, deviation, and a packet loss on the mesh network as a result of the trial IP telephone communication are compared with reference communication states such as a delay time, a deviation ratio, and a packet loss ratio beforehand set in the manager 1. If it is determined that the communication states of the mesh network satisfactorily match the reference communication states, the manager 1 determines that the predetermined communication quality is satisfied. If the communication states of the mesh network do not satisfy the reference communication states, the manager 1 determines that the predetermined communication quality is not satisfied. However, the determination method is not restricted by the embodiment. There may be employed any determination method only if it is possible to determine, according to the communication quality information received from the Access Point F and the mesh portal 10, whether the predetermined communication quality is satisfied.

In the determination of connectibility for IP telephone communication in step S28, the Access Point F determines, according to the connectibility judge result from the manager 1, whether the association request of the station STA for IP telephone communication is granted. However, the determining method is not restricted by the embodiment. It is also possible to determine connectibility of the station STA for IP telephone communication by use of various conditions.

For example, the Access Point F manages the number of stations that can be connected to the Access Point F and that can establish communication lines for IP telephone communication with the Access Point F. Assume that connectibility for IP telephone communication is determined according to the number of stations. By use of, for example, the judge result of connectibility according to the number of stations and the judge result received from the manager 1, if it is determined that the connection of the station STA for IP telephone communication is possible, the association request of the station STA for IP telephone communication is granted. Therefore, it is possible to determine connectibility of the station STA for IP telephone communication in the whole wireless intervals of the mesh network.

In the processing of the second embodiment, when the association request for IP telephone communication is received from the station STA, the Access Point F sends a connection judge request of IP telephone communication to the mesh connection manager 1. However, the connection judge request may be transmitted at timing other than that described above. The request may be delivered to the manager 1 at desired point of time, for example, at prior confirmation of connectibility of IP telephone communication in consideration of handover of the station STA.

Also, in conjunction with the operation of the IP telephone communication system, description has been given of connectibility for IP telephone communication between the additional station STA coupled with Access Point F and the destination station STA linked with an external network. Data is communicated through trial IP telephone communication between the Access Point F and the mesh portal 10 via the relay network to thereby determine connectibility of the additional station STA for IP telephone communication. However, data may be communicated therebetween via various routes on the relay network to obtain communication quality information items resultant from the communication. The communication quality information items of the mutually different routes are compared with each other. According to results of the comparison, the system conducts a control operation to acquire an optimal relay network route having the highest communication quality.

In a situation in which the IP telephone communication is conducted according to priority assigned to each IP packet data in the mesh network under control of the IP telephone communication system, it is favorable that the IP packet data for the pseudo IP telephone communication and that for the trial IP telephone communication are fed to the mesh network with a priority level less than that of the IP packet data actually being transmitted through IP telephone communication. As a result, even if the pseudo IP telephone communication and the trial IP telephone communication are carried out, the load imposed on the mesh network can be reduced. Since IP packet data being transmitted in advance through IP telephone communication on the mesh network can be delivered with a higher priority level, it is possible to mitigate influence upon the transmission of IP packet data actually being delivered through IP telephone communication. The check for connectibility of the additional station STA for IP telephone communication is more severely carried out, and hence there is obtained the judge result of connectibility for IP telephone communication with higher reliability.

### Third Embodiment

Next, description will be given operation of the third embodiment.

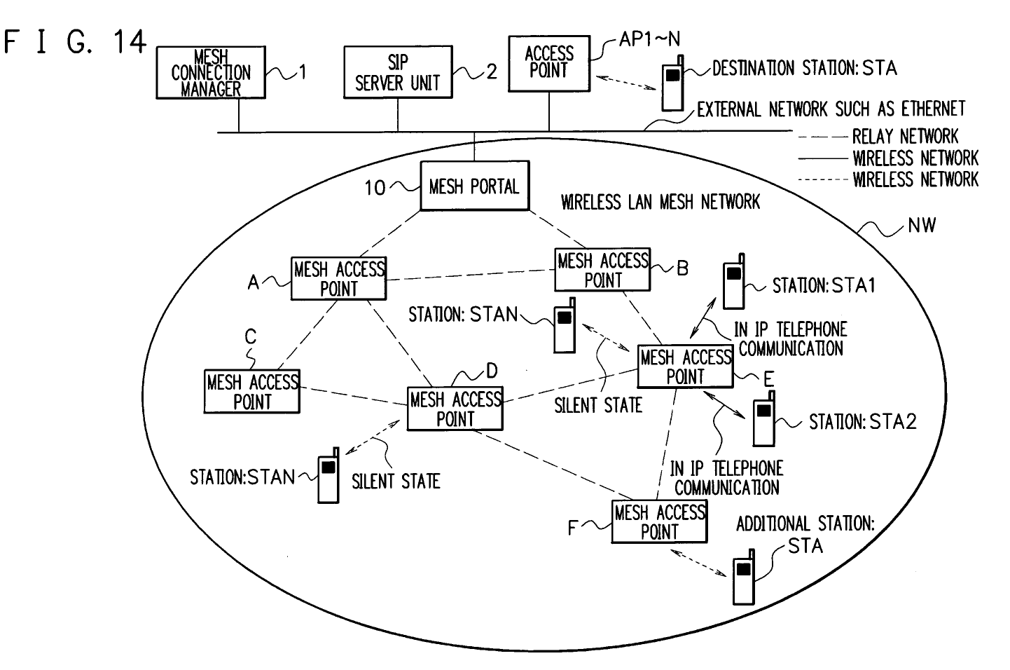

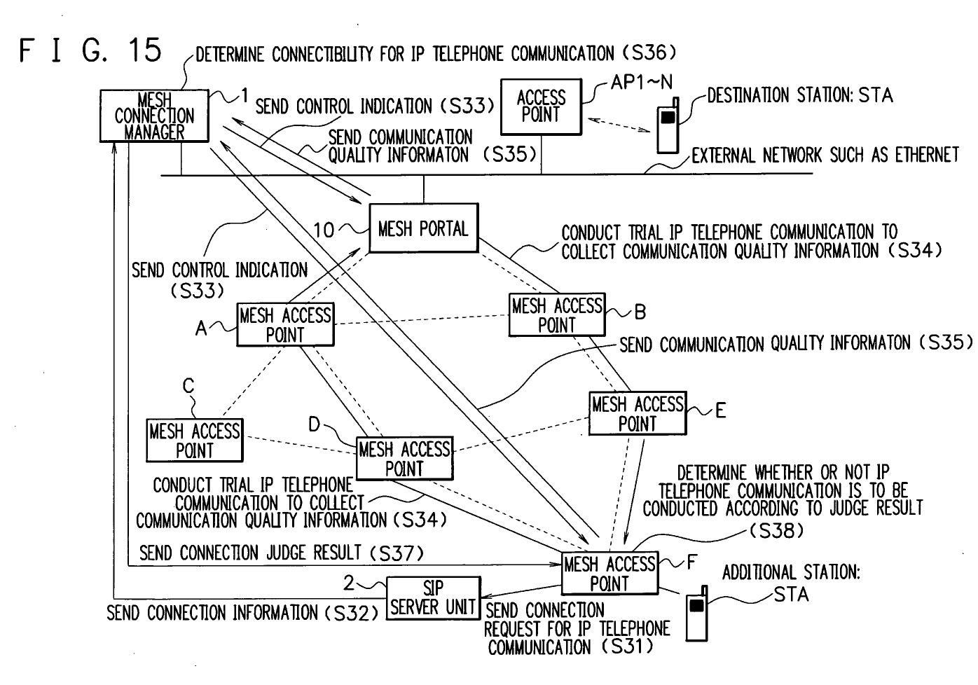

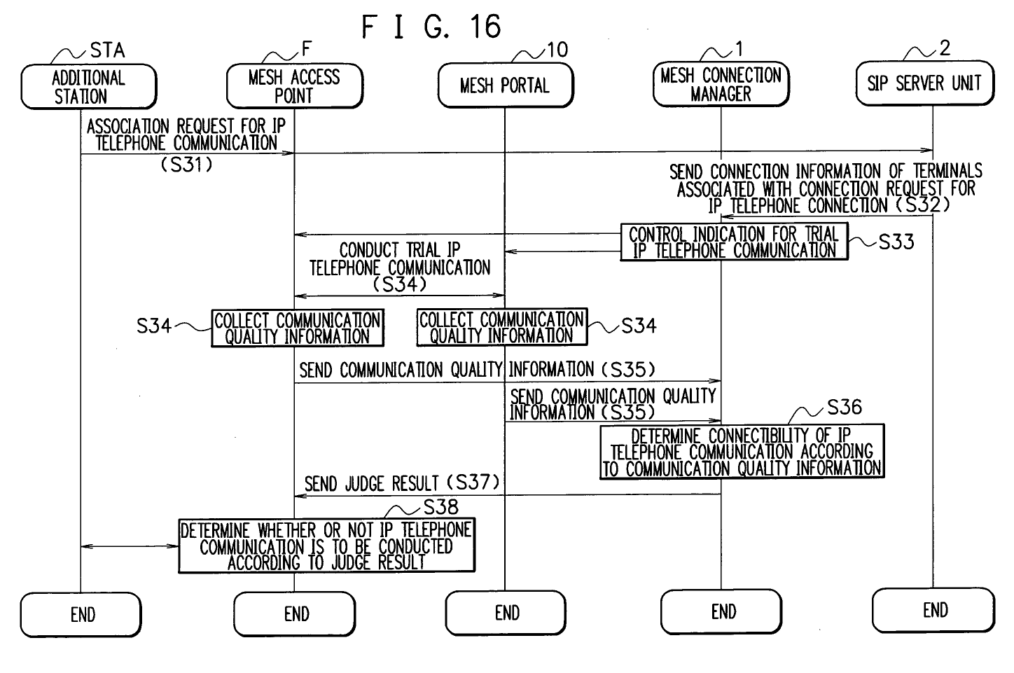

In the second embodiment, as can be seen from FIGS. 12 and 13, when the association request for IP telephone communication is received from the additional station STA (step S21), the mesh Access Point F delivers a connection judge request for IP telephone communication in response to the association request to the mesh connection manager 1 (step S22). The manager 1 sends a control indication to conduct trial IP telephone communication to the Access Point F connected to the additional station STA as the request source of the connection and the mesh portal 10 coupled with the destination station STA as the destination of the association request (step S23). In contrast therewith, in an IP telephone communication system of the third embodiment shown in FIGS. 15 and 16, at reception of the association request for IP telephone communication from the additional station STA (step S31), an SIP server unit 2 to manage the connection control of IP telephone communication between the additional station STA and the destination station STA transmits connection information between the additional station STA and the destination station STA to the manager 1 (step S32). Based on the connection information, the manager 1 delivers a control indication to conduct trial IP telephone communication to the Access Point F coupled with the additional station STA as the request source of the connection and the portal 10 connected to the destination station STA (step S33) to resultantly carry out the trial IP telephone communication between the Access Point F and the portal 10 (step S34). As above, it is possible to conduct the trial IP telephone communication on the basis of the connection information from the SIP server 2. Referring now to FIGS. 14 to 16, description will be given in detail of structure and operation of the third embodiment.

First, referring to FIG. 14, description will be given of the configuration of the third embodiment.

The IP telephone communication system includes a mesh connection managing unit 1, a mesh portal 10, a plurality of mesh Access Points A to F, a plurality of stations STA1 to STAN, and an SIP server 2.

In comparison with the structure of the second embodiment shown in FIG. 8, the configuration of the third embodiment additionally includes the SIP server 2 to manage connection control for IP telephone communication. That is, the SIP server 2 controls connection for IP telephone communication between the additional station STA and the destination station STA.

Referring next to FIGS. 15 and 16, description will be given of a sequence of operations in the third embodiment. In the operation, as in the operation of the second embodiment, an additional station STA not having established a communication line for IP telephone communication with any Access Point (A to F) on the mesh network issues to the Access Point F an association request for IP telephone communication with the destination station STA coupled with an external network as shown in FIGS. 15 and 16.

Each of the Access Points A to F and the mesh portal 10 on the mesh network carry out operations similar to the control operation shown in FIG. 6 to set the stations STA1 to STAN having established communication lines for IP telephone communication with the Access Points A to F or the mesh portal 10 to a state in which the stations are virtually communicating data through IP telephone communication.

As a result, by setting any station (STA1 to STAN) having established a communication line for IP telephone communication with either one of the Access Points A to F or the portal 10 to the state of communicating data through virtual IP telephone communication, it is possible to set the wireless LAN mesh network NW to the maximum band state.

Subsequently, in the maximum band state of the mesh network, an additional station STA not having established a communication line for IP telephone communication sends, via the Access Point F to the SIP server 2, an association request (INVITE) for IP telephone communication with a destination station STA coupled with an external network (step S31).

After having received the association request (INVITE), the SIP server 2 transmits connection information between the connection source station STA and the destination station STA to the manager 1 (step S32).

When the connection information is received, the manager 1 identifies, using the information, the Access Point F linked with the source station STA and the portal 10 coupled with the destination station STA. The manager 1 delivers a control instruction to the Access Point F and the portal 10 to conduct trial IP telephone communication (step S33).

The Access Point F and the portal 10 receive the control indication and then carry out operation as in the second embodiment. Specifically, each thereof creates trial IP packet data including dummy data capable of identifying IP telephone communication on the mesh network NW. The Access Point F and the portal 10 mutually communicate the trial IP packet data via a relay network with each other to gather communication quality information such as delay, deviation, a packet loss required to evaluate quality of the IP telephone communication (step S34). Processing in steps 35 to 38 is similar to that of steps S25 to S28 of the second embodiment.

In the third embodiment, when a association request (INVITE) for IP telephone communication is received from an additional station STA to start IP telephone communication, the SIP server 2 controlling connection for IP telephone communication sends connection information between the additional station STA and a destination station STA to the mesh connection manager 1. When the connection information is received, the manager 1 identifies, according to the information, a mesh Access Point F and a mesh portal 10 coupled with the additional station STA and the destination station STA and then makes the mesh Access Point F and the mesh portal 10 execute trial IP telephone communication. Resultantly, as in the second embodiment, it is possible to determine, in the maximum band state of the mesh network, connectibility of the additional station STA for IP telephone communication. Therefore, even in a situation in which the stations (STA1 to STAN) having established communication lines for IP telephone communication on the wireless LAN mesh network NW include a station STAN in the silent state not communicating data through mesh Access Point F and a mesh portal 10, the communication system can determine connectibility for IP telephone communication with high reliability.

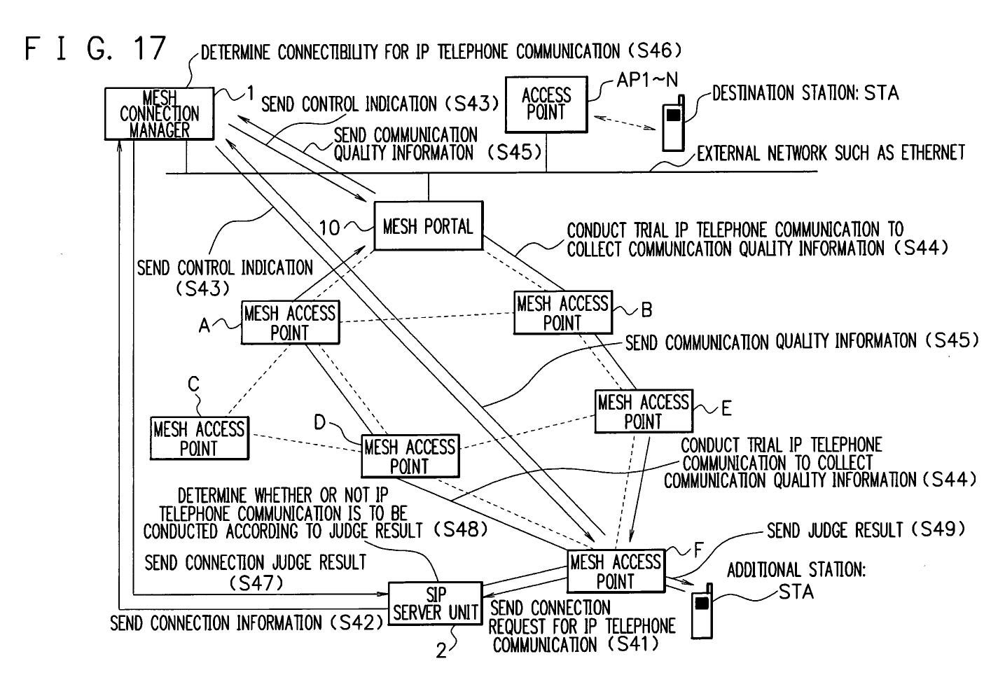

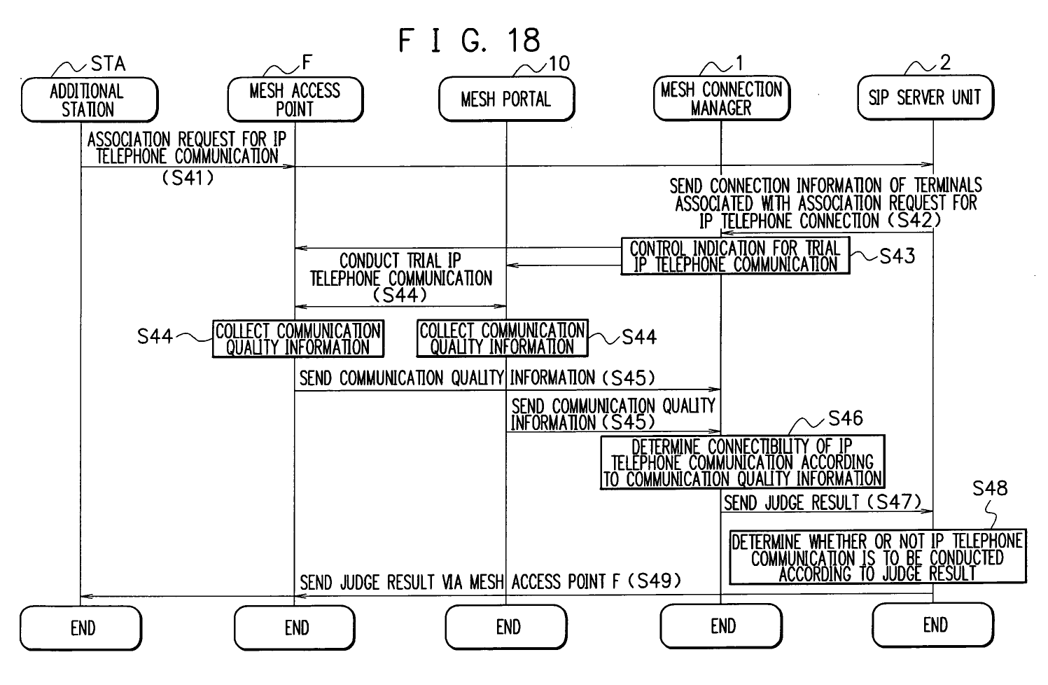

As can be seen from FIGS. 15 and 16, in the third embodiment, the manager 1 sends the judge result of connectibility for IP telephone communication to the Access Point F (step S37). On the basis of the judge result received from the manager 1, the Access Point F determines whether the association request from the additional station STA is granted (step S38). However, as shown in FIGS. 17 and 18, the manager 1 may deliver the judge result to the SIP server 2 (step S47). The SIP server 2 receives the judge result to determine according to the result whether the association request from the additional station STA is accepted (step S48) and then feeds the result of determination via the Access Point F to the additional station STA (step S49). If the SIP server 2 rejects, based on the judge result from the manager 1, the association request from the additional station STA, it is also possible to transmit to the additional station STA an error message and/or a connection rejection message indicating that the association request for the IP telephone communication is not acceptable.

In this connection, the embodiments above are only favorable embodiments of the present invention. The present invention is not restricted by the embodiments and the embodiments can be modified and changed in various ways within the scope and the spirit of the present invention.

For example, although the mesh connection manager 1 of the second and third embodiments is arranged on an external network, it is possible to dispose the manager 1 on the mesh network by use of, for example, an extended function of the mesh Access Points A to F. Also, the function of the manager 1 may be installed in the respective Access Points A to F.

The timing at which control devices such as the Access Points AP1 to APN of the first embodiment and the mesh Access Points A to F and the mesh portal 10 of the second and third embodiments conduct the control operation as shown in FIG. 6 does not restrict the present invention. It is only required that the control operation be carried out before the additional station STA issues an association request for IP telephone communication. The control devices may conduct the control operation of FIG. 6 in any situation. A plurality of control devices on one and the same network may carry out the control operation with synchronization established therebetween. Or, the control devices may conduct the control operation at issuance of the association request for IP telephone communication from the additional station.

In the embodiments of an IP telephone communication system, the judge criterion to determine whether a station has established a communication line for IP telephone communication does not restrict the present invention. The determination may be conducted according to a judge criterion prescribed in one of various system control operations. In short, any judge criterion may be available only if it is possible to manage stations having established communication lines for IP telephone communication.

Also, in the embodiments, the silent station STAN in the silent state is not limited to a station not communicating data through IP telephone communication due to use of, for example, a silent compression function. The silent station includes a station for which a band is secured for IP telephone communication in the IP telephone communication system and which is not conducting IP telephone communication.

The control operation of the control devices such as the Access Points AP1 to APN of the first embodiment and the mesh connection managing unit 1, the mesh Access Points A to F, and the mesh portal 10 of the second embodiment may be conducted by not only a hardware configuration but also by a software configuration including software such as a computer program. The program may be recorded in a recording medium, for example, an optical recording medium, a magnetic recording medium, a magnetooptical recording medium, or a semiconductor recording medium such that the program is read therefrom to be loaded in the control devices for the control operation. Also, the program may be loaded in the control devices via a predetermined network from an external device connected thereto so that the devices carry out the control operation.

The connection controller, the IP telephone communication system, the connection control method, and the connection control program in accordance with the present invention are applicable to IP telephone communication of multimedia data including audio data and video data as well as to a network environment including a station in the silent state not communicating data through IP telephone communication.

What is claimed is:

1. A connection controller, comprising:
a silent state judge section that determines presence or absence of a station in a silent state not conducting IP telephone communication among stations having established communication lines for IP telephone communication; and
a pseudo IP telephone communication conducting section that conducts, when presence of the station in a silent state is determined, pseudo IP telephone communication corresponding to a state in which the station in a silent state conducts IP telephone communication.

2. The connection controller in accordance with claim 1, wherein the pseudo IP telephone communication conducting section creates pseudo IP packet data corresponding to a state in which the station in a silent state conducts IP telephone communication and sends the packet data to a network.

3. The connection controller in accordance with claim 2, wherein the pseudo IP telephone communication conducting section sends the packet data to a network by assigning a higher priority level to IP packet data actually in IP telephone communication.

4. The connection controller in accordance with claim 1, further comprising an IP telephone connectibility judge section that determines, in a state in which the pseudo IP telephone communication is being conducted, connectibility of IP telephone communication of an additional station additionally desiring IP telephone communication.

5. The connection controller in accordance with claim 4, wherein the IP telephone connectibility judge section conducts trial IP telephone communication between the additional station and an Access Point coupled with a destination station to conduct IP telephone communication with the additional station, via a network; determines as a result of the trial IP telephone communication whether a predetermined band is securable on the network; determines that the IP telephone communication is connectable if it is determined that the predetermined band is securable; and determines that the IP telephone communication is not connectable if it is determined that the predetermined band is not securable.

6. The connection controller in accordance with claim 4, wherein the IP telephone connectibility judge section conducts trial IP telephone communication between the additional station and a Access Point coupled with a destination station to conduct IP telephone communication with the additional station, via a network; collects communication quality information associated with communication quality of the trial IP telephone communication; sends the communication quality information to a connection managing unit managing connection control of IP telephone communication for the additional station; receives a judge result obtained by the connection managing unit by determining, based on the communication quality information, connectibility of IP telephone communication for the additional station; determines connectibility of IP telephone communication on the basis of the judge result; determines that the IP telephone communication is connectable if the judge result indicates connectibility of the IP telephone communication; and determines that the IP telephone communication is not connectable if the judge result does not indicate connectibility of the IP telephone communication.

7. The connection controller in accordance with claim 5, wherein the IP telephone connectibility judge section communicates trial IP packet data with the Access Point via the network to thereby conduct the trial IP telephone communication.

8. The connection controller in accordance with claim 7, wherein the IP telephone connectibility judge section controls to communicate the trial IP packet data by assigning a higher priority level to IP packet data actually in IP telephone communication.

9. The connection controller in accordance with claim 6, wherein the IP telephone connectibility judge section communicates trial IP packet data with the Access Point via the network to thereby conduct the trial IP telephone communication.

10. The connection controller in accordance with claim 9, wherein the IP telephone connectibility judge section controls to communicate the trial IP packet data by assigning a higher priority level to IP packet data actually in IP telephone communication.

11. The connection controller in accordance with claim 1, wherein the silent state judge section analyzes the IP packet data sent from the station, checks a transmission state of the IP packet data to determine whether the IP packet data of IP telephone communication 5 is transmitted, and determines presence of a station in a silent state if it is determined that the IP packet data of IP telephone communication is not transmitted.

12. The connection controller in accordance with claim 11, wherein:
the IP packet data includes judge information to determine whether the IP packet data is data of IP packet data of telephone communication; and
the silent state judge section analyzes the IP packet data sent from the station, checks a transmission state of the IP packet data to determine, based on the judge information, whether the IP packet data of IP telephone communication is transmitted, and determines presence of a station in a silent state if it is determined that the IP packet data of IP telephone communication is not transmitted.

13. The connection controller in accordance with claim 4, wherein the IP telephone connectibility judge section determines, when the association request for IP telephone communication is received from the additional station, connectibility of IP telephone communication for the additional station.

14. The connection controller in accordance with claim 4, wherein the IP telephone connectibility judge section determines, when a control indication is received from a connection managing unit managing connection control of IP telephone communication for the additional station, connectibility of IP telephone communication for the additional station.

15. An IP telephone communication system including a plurality of Access Points and stations under control of the Access Points, wherein each of the Access Points comprises:
a silent state judge section that determines presence or absence of a station in a silent state not conducting IP telephone communication among stations having established communication lines for IP telephone communication; and
a pseudo IP telephone communication conducting section that conducts, when presence of the station in a silent state is determined, pseudo IP telephone communication corresponding to a state in which the station in a silent state conducts IP telephone communication.

16. The IP telephone communication system in accordance with claim 15, wherein the Access Point creates pseudo IP packet data corresponding to a state in which the station in a silent state conducts IP telephone communication and sends the packet data to a network.

17. The IP telephone communication system in accordance with claim 16, wherein the Access Point controls to send the packet data to a network by assigning a higher priority level to IP packet data actually in IP telephone communication.

18. The IP telephone communication system in accordance with claim 15, further a comprising IP telephone connectibility judge section that determines, in a state in which the pseudo IP telephone communication is being conducted, connectibility of IP telephone communication of an additional station additionally desiring IP telephone communication.

19. The IP telephone communication system in accordance with claim 18, wherein the Access Point conducts trial IP telephone communication between the additional station and a second Access Point coupled with a destination station to conduct IP telephone communication with the additional station, via a network; determines as a result of the trial IP telephone communication whether a predetermined band is securable on the network; determines that the IP telephone communication is connectable if it is determined that the predetermined band is securable; and determines that the IP telephone communication is not connectable if it is determined that the predetermined band is not securable.

20. The IP telephone communication system in accordance with claim 18, further comprising a connection managing unit that manages connection control of IP telephone communication for the additional station, wherein the Access Point conducts trial IP telephone communication between the additional station and a second Access Point coupled with a destination station to conduct IP telephone communication with the additional station, via a network; collects communication quality information associated with communication quality of the trial IP telephone communication; sends the communication quality information to the connection managing unit; receives from the connection managing unit a judge result obtained by the connection managing unit by determining, based on the communication quality information, connectibility of IP telephone communication for the additional station; determines connectibility of IP telephone communication on the basis of the judge result; determines that the IP telephone communication is connectable if the judge result indicates connectibility of the IP telephone communication; and determines that the IP telephone communication is not connectable if the judge result does not indicate connectibility of the IP telephone communication.

21. The IP telephone communication system in accordance with claim 19, wherein the Access Point communicates trial IP packet data with the Access Point via the network to thereby conduct the trial IP telephone communication.

22. The IP telephone communication system in accordance with claim 21, wherein the Access Point controls to communicate the trial IP packet data by assigning a higher priority level to IP packet data actually in IP telephone communication.

23. The IP telephone communication system in accordance with claim 20, wherein the Access Point communicates trial IP packet data with the Access Point via the network to thereby conduct the trial IP telephone communication.

24. The IP telephone communication system in accordance with claim 23, wherein the Access Point controls to communicate the trial IP packet data by assigning a higher priority level to IP packet data actually in IP telephone communication.

25. The IP telephone communication system in accordance with claim 15, wherein the Access Point analyzes the IP packet data sent from the station, checks a transmission state of the IP packet data to determine whether the IP packet data of IP telephone 5 communication is transmitted, and determines presence of a station in a silent state if it is determined that the IP packet data of IP telephone communication is not transmitted.

26. The IP telephone communication system in accordance with claim 25, wherein:
the IP packet data includes judge information to determine whether the IP packet data is data of IP packet data of telephone communication; and
the Access Point analyzes the IP packet data sent from the station, checks a transmission state of the IP packet data to determine, based on the judge information, whether the IP packet data of IP telephone communication is transmitted, and determines presence of a station in a silent state if it is determined that the IP packet data of IP telephone communication is not transmitted.

27. The IP telephone communication system in accordance with claim 18, wherein the Access Point determines, when the association request for IP telephone communication is received from the additional station, connectibility of IP telephone communication for the additional station.

28. The IP telephone communication system in accordance with claim 18, wherein the Access Point determines, when a control indication is received from a connection managing unit managing connection control of IP telephone communication for the additional station, connectibility of IP telephone communication for the additional station.

29. The IP telephone communication system in accordance with claim 15, further comprising a connection managing unit that manages connection control of IP telephone communication for an additional station desiring to conduct IP telephone communication, wherein
the connection managing unit comprises an IP telephone connectibility judge section that determines, in a state in which the wireless station is conducting the pseudo IP telephone communication, connectibility of the IP telephone communication for the additional station in a second Access Point coupled with the additional station.

30. The IP telephone communication system in accordance with claim 29, wherein the connection managing unit conducts trial IP telephone communication between a first Access Point coupled with the additional station and a second Access Point coupled with a destination station to conduct IP telephone communication with the additional station, via a network; collects communication quality information associated with communication quality of the trial IP telephone communication via the network from the first and second Access Points; and determines connectibility of IP telephone communication on the basis of the communication quality information.

31. The IP telephone communication system in accordance with claim 30, wherein:
the connection managing unit sends a control indication to conduct the trial IP telephone communication to the first and second Access Points; and
the first and second Access Points communicate, at reception of the control indication, trial IP packet data therebetween via a network to thereby conduct the trial IP telephone communication.

32. The IP telephone communication system in accordance with claim 30, wherein the connection managing unit determines whether the communication quality information is less than predetermined communication quality, determines that the IP telephone communication is connectable if it is determined that the communication quality information is equal to or more than predetermined communication quality, and determines that the IP telephone communication is not connectable if it is determined that the communication quality information is less than predetermined communication quality.

33. The IP telephone communication system in accordance with claim 31, wherein the first and second Access Points communicate the trial IP packet data with each other by assigning a higher priority level to IP packet data actually in IP telephone communication.

34. A connection control method to be used by a connection control device for determining connectibility of IP telephone communication, comprising:
a silent state judge step of determining presence or absence of a station in a silent state not conducting IP telephone communication among stations having established communication lines for IP telephone communication with the connection control device; and
a pseudo IP telephone communication conducting step of conducting, when presence of the station in a silent state is determined, pseudo IP telephone communication corresponding to a state in which the station in a silent state conducts IP telephone communication,
the silent state judge step and the pseudo IP telephone communication conducting step being conducted by the connection control device.

35. The connection control method in accordance with claim 34, wherein the pseudo IP telephone communication conducting step comprises creating IP packet data corresponding to a state in which the station in a silent state conducts IP telephone communication and sending the packet data to a network.

36. The connection control method in accordance with claim 35, wherein the pseudo IP telephone communication conducting step comprises controlling to send the packet data to a network by assigning a higher priority level to IP packet data actually in IP telephone communication.

37. The connection control method in accordance with claim 34, further comprising an IP telephone connectibility judge step of determining, in a state in which the pseudo IP telephone communication is being conducted, connectibility of IP telephone communication of an additional station additionally desiring IP telephone communication,
the IP telephone connectibility judge step being conducted by the connection control device.

38. The connection control method in accordance with claim 37, wherein the IP telephone connectibility judge step comprises conducting trial IP telephone communication between the additional station and a Access Point coupled with a destination station to conduct IP telephone communication with the additional station, via a network; determining as a result of the trial IP telephone communication whether a predetermined band is securable on the network; determining that the IP telephone communication is connectable if it is determined that the predetermined band is securable; and determining that the IP telephone communication is not connectable if it is determined that the predetermined band is not securable.

39. The connection control method in accordance with claim 37, wherein the IP telephone connectibility judge step comprises conducting trial IP telephone communication between the additional station and a Access Point coupled with a destination station to conduct IP telephone communication with the additional station, via a network; collecting communication quality information associated with communication quality of the trial IP telephone communication; sending the communication quality information to a connection managing unit managing connection control of IP telephone communication for the additional station; receiving a judge result obtained by the connection managing unit by determining, based on the communication quality information, connectibility of IP telephone communication for the additional station; determining connectibility of IP telephone communication on the basis of the judge result; determining that the IP telephone communication is connectable if the judge result indicates connectibility of the IP telephone communication; and determining that the IP telephone communication is not connectable if the judge result does not indicate connectibility of the IP telephone communication.

40. The connection control method in accordance with claim 38, wherein the IP telephone connectibility judge step comprises communicating trial IP packet data with the Access Point via the network to thereby conduct the trial IP telephone communication.

41. The connection control method in accordance with claim 40, wherein the IP telephone connectibility judge step comprises controlling to communicate the trial IP packet data by assigning a higher priority level to IP packet data actually in IP telephone communication.

42. The connection control method in accordance with claim 39, wherein the IP telephone connectibility judge step comprises communicating trial IP packet data with the Access Point via the network to thereby conduct the trial IP telephone communication.

43. The connection control method in accordance with claim 42, wherein the IP telephone connectibility judge step comprises controlling to communicate the trial IP packet data by assigning a higher priority level to IP packet data actually in IP telephone communication.

44. The connection control method in accordance with claim 34, wherein the silent state judge step comprises analyzing the IP packet data sent from the station, checking a transmission state of the IP packet data to determine whether the IP packet data of IP telephone communication is transmitted, and determining presence of a station in a silent state if it is determined that the IP packet data of IP telephone communication is not transmitted.

45. The connection control method in accordance with claim 44, wherein:
the IP packet data includes judge information to determine whether the IP packet data is data of IP packet data of telephone communication; and
the silent state judge step comprises analyzing the IP packet data sent from the station, checking a transmission state of the IP packet data to determine, based on the judge information, whether the IP packet data of IP telephone communication is transmitted, and determining presence of a station in a silent state if it is determined that the IP packet data of IP telephone communication is not transmitted.

46. The connection control method in accordance with claim 37, wherein the IP telephone connectibility judge step comprises determining, when the association request for IP telephone communication is received from the additional station, connectibility of IP telephone communication for the additional station.

47. The connection control method in accordance with claim 37, wherein the IP telephone connectibility judge step comprises determining, when a control indication is received from a connection managing unit managing connection control of IP telephone communication for the additional station, connectibility of IP telephone communication for the additional station.

48. A computer program for use with a connection control device for determining connectibility of IP telephone communication, causing the connection control device to perform:
silent state judge processing for determining presence or absence of a station in a silent state not conducting IP telephone communication among stations having established communication lines for IP telephone communication with the connection control device; and
pseudo IP telephone communication conducting processing for conducting, when presence of the station in a silent state is determined, pseudo IP telephone communication corresponding to a state in which the station in a silent state conducts IP telephone communication.

49. The computer program in accordance with claim 48, wherein the pseudo IP telephone communication conducting processing comprises creating pseudo IP packet data corresponding to a state in which the station in a silent state conducts IP telephone communication and sending the packet data to a network.

50. The computer program in accordance with claim 49, wherein the pseudo IP telephone communication conducting processing comprises controlling to send the packet data to a network by assigning a higher priority level to IP packet data actually in IP telephone communication.

51. The computer program in accordance with claim 48, further causing the connection control device to perform IP telephone connectibility judge processing for determining, in a state in which the pseudo IP telephone communication is being conducted, connectibility of IP telephone communication of an additional station additionally desiring IP telephone communication.

52. The computer program in accordance with claim 51, wherein the IP telephone connectibility judge processing comprises conducting trial IP telephone communication between the additional station and a Access Point coupled with a destination station to conduct IP telephone communication with the additional station, via a network; determining as a result of the trial IP telephone communication whether a predetermined band is securable on the network; determining that the IP telephone communication is connectable if it is determined that the predetermined band is securable; and determining that the IP telephone communication is not connectable if it is determined that the predetermined band is not securable.

53. The computer program in accordance with claim 51, wherein the IP telephone connectibility judge processing comprises conducting trial IP telephone communication between the additional station and a Access Point coupled with a destination station to conduct IP telephone communication with the additional station, via a network; collecting communication quality information associated with communication quality of the trial IP telephone communication; sending the communication quality information to a connection managing unit managing connection control of IP telephone communication for the additional station; receiving a judge result obtained by the connection managing unit by determining, based on the communication quality information, connectibility of IP telephone communication for the additional station; determining connectibility of IP telephone communication on the basis of the judge result; determining that the IP telephone communication is connectable if the judge result indicates connectibility of the IP telephone communication; and determining that the IP telephone communication is not connectable if the judge result does not indicate connectibility of the IP telephone communication.

54. The computer program in accordance with claim 52, wherein the IP telephone connectibility judge processing comprises communicating trial IP packet data with the Access Point via the network to thereby conduct the trial IP telephone communication.

55. The connection control program in accordance with claim 54, wherein the IP telephone connectibility judge processing comprises communicating the trial IP packet data by assigning a higher priority level to IP packet data actually in IP telephone communication.

56. The computer program in accordance with claim 53, wherein the IP telephone connectibility judge processing comprises communicating trial IP packet data with the Access Point via the network to thereby conduct the trial IP telephone communication.

57. The connection control program in accordance with claim 56, wherein the IP telephone connectibility judge processing comprises communicating the trial IP packet data by assigning a higher priority level to IP packet data actually in IP telephone communication.

58. The connection control program in accordance with claim 48, wherein the silent state judge processing comprises analyzing the IP packet data sent from the station, checking a transmission state of the IP packet data to determine whether or not the IP packet data of IP telephone communication is transmitted, and determining presence of a station in a silent state if it is determined that the IP packet data of IP telephone communication is not transmitted.

59. The computer program in accordance with claim 58, wherein:
the IP packet data includes judge information to determine whether the IP packet data is data of IP packet data of telephone communication; and
the silent state judge processing comprises analyzing the IP packet data sent from the station, checking a transmission state of the IP packet data to determine, based on the judge information, whether the IP packet data of IP telephone communication is transmitted, and determining presence of a station in a silent state if it is determined that the IP packet data of IP telephone communication is not transmitted.

60. The computer program in accordance with claim 48, wherein the IP telephone connectibility judge processing comprises determining, when the association request for IP telephone communication is received from the additional station, connectibility of IP telephone communication for the additional station.

61. The computer program in accordance with claim 48, wherein the IP telephone connectibility judge processing comprises determining, when a control indication is received from a connection managing unit managing connection control of IP telephone communication for the additional station, connectibility of IP telephone communication for the additional station.
